(19) United States
(12) Patent Application Publication
(10) Pub. No.: US 2017/0221442 A1
(43) Pub. Date: Aug. 3, 2017

(54) DISPLAY DEVICE

(71) Applicants: BOE Technology Group Co., Ltd., Beijing (CN); Beijing BOE Display Technology Co., Ltd., Beijing (CN)

(72) Inventors: Zhenyu Zhang, Beijing (CN); Yanping Liao, Beijing (CN); Chunguang Tian, Beijing (CN); Tianyu Xia, Beijing (CN); Fangyu Wang, Beijing (CN)

(21) Appl. No.: 15/236,576

(22) Filed: Aug. 15, 2016

(30) Foreign Application Priority Data
Feb. 3, 2016 (CN) 201610076163.7

(51) Int. Cl. G09G 3/36; G02F 1/1343; G02F 1/1362; G02F 1/1335

(52) U.S. Cl. CPC G09G 3/3685; G02F 1/133514; G02F 1/134336; G02F 1/136286; G02F 2001/134345

(57) ABSTRACT

In some embodiments, a display device includes a first substrate and a second substrate and a pixel arrangement disposed therebetween; wherein, the pixel arrangement includes a plurality of rows of sub-pixel unit sets, odd-numbered rows of sub-pixel unit sets and gate lines and data lines for driving the same are provided on the first substrate, and even-numbered rows of sub-pixel unit sets and gate lines and data lines for driving the same are provided on the second substrate; or, the pixel arrangement includes a plurality of columns of sub-pixel unit sets, odd-numbered columns of sub-pixel unit sets and gate lines and data lines for driving the same are provided on the first substrate, and even-numbered columns of sub-pixel unit sets and gate lines and data lines for driving the same are provided on the second substrate.

### CROSS-REFERENCE TO RELATED APPLICATION

This application claims the benefit of Chinese Patent Application No. 201610076163.7 filed on Feb. 3, 2016 in the State Intellectual Property Office of China, the whole disclosure of which is incorporated herein by reference.

### BACKGROUND

1. Technical Field

Embodiments of the present invention relate to the field of display technology, and particularly to a display device.

2. Description of the Related Art

Demands on large size and high resolution liquid crystal panels surge along with the rapid development of LCD industry. As size of the liquid crystal panels required by the market is gradually increasing, it becomes a research hotspot in the field that how to realize the design of large size and high resolution display device.

### SUMMARY

Embodiments of the present invention provide a display device comprising a first substrate and a second substrate which are opposite to each other, and a pixel arrangement disposed between the first substrate and the second substrate; wherein, the pixel arrangement comprises a plurality of rows of sub-pixel unit sets, and, each row of sub-pixel unit sets comprises at least one row of sub-pixel units; in the pixel arrangement, odd-numbered rows of sub-pixel unit sets and even-numbered rows of sub-pixel unit sets are provided on the first substrate and the second substrate, respectively; and, the first substrate is provided with gate lines and data lines for driving the odd-numbered rows of sub-pixel unit sets, while the second substrate is provided with gate lines and data lines for driving the even-numbered rows of sub-pixel unit sets; or,

the pixel arrangement comprises a plurality of columns of sub-pixel unit sets, and, each column of sub-pixel unit sets comprises at least one column of sub-pixel units; in the pixel arrangement, odd-numbered columns of sub-pixel unit sets and even-numbered columns of sub-pixel unit sets are provided on the first substrate and the second substrate, respectively; and, the first substrate is provided with gate lines and data lines for driving the odd-numbered columns of sub-pixel unit sets, while the second substrate is provided with gate lines and data lines for driving the even-numbered columns of sub-pixel unit sets.

In some embodiments, each row of sub-pixel unit sets comprises one row of sub-pixel units; or, each column of sub-pixel unit sets comprises one column of sub-pixel units.

In some embodiments, the display device may further comprise a color filter layer disposed between the first substrate and the second substrate.

In some embodiments, the color filter layer is provided on the first substrate; or, the color filter layer is provided on the second substrate.

In some embodiments, the color filter layer may comprise a first portion corresponding to the odd-numbered rows of sub-pixel unit sets and a second portion corresponding to the even-numbered rows of sub-pixel unit sets; or, the color filter layer may comprise a first portion corresponding to the odd-numbered columns of sub-pixel unit sets and a second portion corresponding to the even-numbered columns of sub-pixel unit sets; wherein, the first portion of the color filter layer is provided on the first substrate, and the second portion of the color filter layer is provided on the second substrate.

In some embodiments, the display device may further comprise a first driving circuit provided on the first substrate and configured to control drivings of the odd-numbered rows of sub-pixel unit sets, and a second driving circuit provided on the second substrate and configured to control drivings of the even-numbered rows of sub-pixel unit sets; or, a first driving circuit provided on the first substrate and configured to control drivings of the odd-numbered columns of sub-pixel unit sets, and a second driving circuit provided on the second substrate and configured to control drivings of the even-numbered columns of sub-pixel unit sets.

In some embodiments, the first driving circuit may comprise a first gate driving circuit that is in a signal connection with the gate lines provided on the first substrate, the second driving circuit may comprise a second gate driving circuit that is in a signal connection with the gate lines provided on the second substrate, and, both the first gate driving circuit and the second gate driving circuit are Gate On Array circuits.

In some embodiments, the first driving circuit may comprise a first drain driving circuit that is in a signal connection with the data lines provided on the first substrate, the second driving circuit may comprise a second drain driving circuit that is in a signal connection with the data lines provided on the second substrate, and, the first drain driving circuit and the second drain driving circuit are provided respectively on both opposite side edges of the display device.

### BRIEF DESCRIPTION OF THE DRAWINGS

FIG. 1 is a schematic view of a structure of a first substrate in a display device according to an embodiment of the present invention;

FIG. 2 is a schematic view of a structure of a second substrate in the display device according to the embodiment of the present invention;

FIG. 3 is a schematic view of a structure of the display device according to the embodiment of the present invention;

FIG. 4 is a schematic view of a structure of a first substrate in a display device according to another embodiment of the present invention;

FIG. 5 is a schematic view of a structure of a second substrate in the display device according to the another embodiment of the present invention; and

FIG. 6 is a schematic view of a structure of the display device according to the another embodiment of the present invention;

### DETAILED DESCRIPTION OF THE EMBODIMENTS

Technical solutions disclosed in these embodiments of the present invention will be described hereinafter clearly and completely with reference to the attached drawings. Obviously, the embodiments illustrated in these drawings are only some of embodiments of the present invention, instead of all of the embodiments of the present invention. For those skilled in the art, other embodiments achieved by referring to the following embodiments without involving any inventive steps fall into the scope of the present invention.

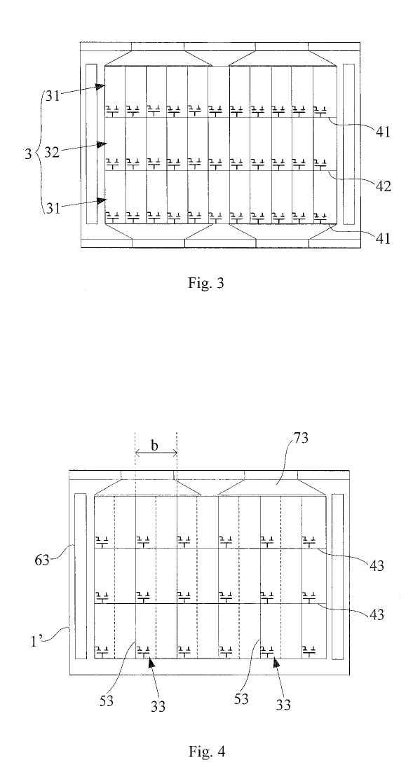

Please refer to FIGS. 1-6.

As shown in FIGS. 1-6, a display device according to the embodiments of the present invention comprises a first substrate 1, 1′ and a second substrate 2, 2′ which are opposite to each other, and a pixel arrangement 3, 3′ disposed between the first substrate 1, 1′ and the second substrate 2, 2′.

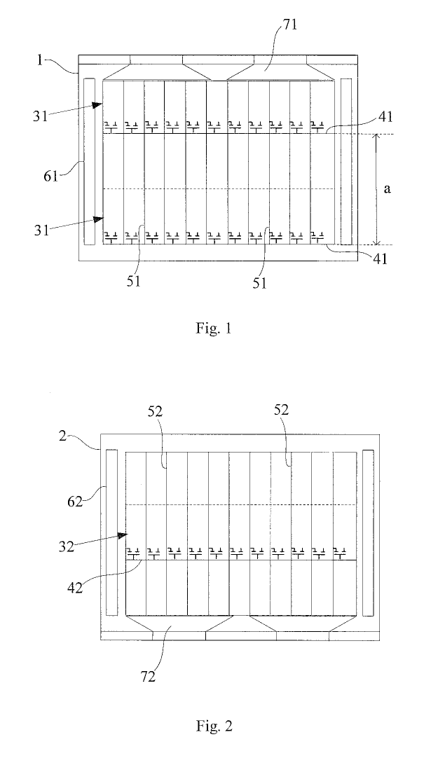

In the embodiment shown in FIG. 1 and FIG. 2, the pixel arrangement 3 comprises a plurality of rows of sub-pixel unit sets, and, each row of sub-pixel unit sets comprises at least one row of sub-pixel units; in the pixel arrangement 3, the odd-numbered rows of sub-pixel unit sets 31 and the even-numbered rows of sub-pixel unit sets 32 are provided on the first substrate 1 and the second substrate 2, respectively; and, the first substrate 1 is provided with gate lines 41 and data lines 51 for driving the odd-numbered rows of sub-pixel unit sets 31, while the second substrate 2 is provided with gate lines 42 and data lines 52 for driving the even-numbered rows of sub-pixel unit sets 32.

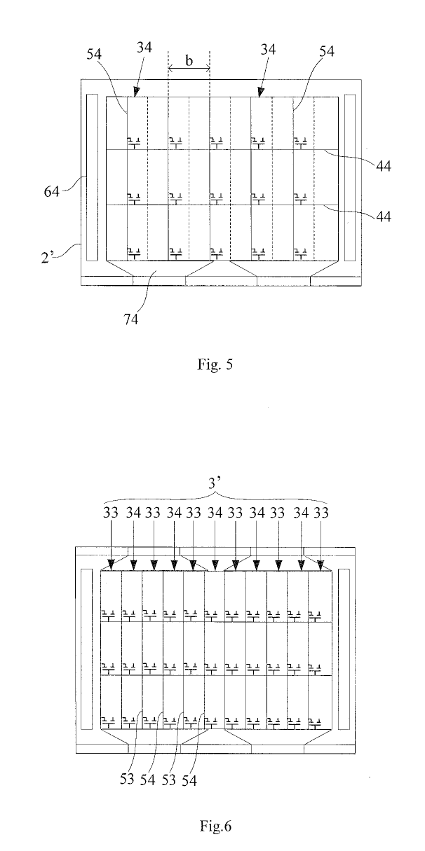

In the embodiment shown in FIG. 4 and FIG. 5, the pixel arrangement 3′ comprises a plurality of columns of sub-pixel unit sets, and, each column of sub-pixel unit sets comprises at least one column of sub-pixel units; in the pixel arrangement 3′, the odd-numbered columns of sub-pixel unit sets 33 and the even-numbered columns of sub-pixel unit sets 34 are provided on the first substrate 1′ and the second substrate 2′, respectively; and, the first substrate 1′ is provided with gate lines 43 and data lines 53 for driving the odd-numbered columns of sub-pixel unit sets 33, while the second substrate 2′ is provided with gate lines 44 and data lines 54 for driving the even-numbered columns of sub-pixel unit sets 34.

In these abovementioned embodiments of the display device, the pixel arrangement 3, 3′ may be divided into a plurality of rows of sub-pixel unit sets or a plurality of columns of sub-pixel unit sets. In the embodiment shown in FIGS. 1-3 where the pixel arrangement 3 is divided into a plurality of rows of sub-pixel unit sets, the odd-numbered rows of sub-pixel unit sets 31 and the even-numbered rows of sub-pixel unit sets 32 are provided on the first substrate 1 and the second substrate 2, respectively; and, the first substrate 1 is provided with gate lines 41 and data lines 51 for driving the odd-numbered rows of sub-pixel unit sets 31, while the second substrate 2 is provided with gate lines 42 and data lines 52 for driving the even-numbered rows of sub-pixel unit sets 32. Here, the number of the gate lines 41 provided on the first substrate 1 equals the number of rows of the sub-pixel units in the odd-numbered rows of sub-pixel unit sets 31, while the number of the sub-pixel units connected to each of the data lines 51 provided on the first substrate 1 equals the number of rows of the sub-pixel units in the odd-numbered rows of sub-pixel unit sets 31. The number of the gate lines 42 provided on the second substrate 2 equals the number of rows of the sub-pixel units in the even-numbered rows of sub-pixel unit sets 32, while the number of the sub-pixel units connected to each of the data lines 52 provided on the second substrate 2 equals the number of rows of the sub-pixel units in the even-numbered rows of sub-pixel unit sets 32. In other words, the plurality of rows of sub-pixel unit sets in the abovementioned pixel arrangement 3 are divided and provided onto two substrates, so that the number of the gate lines on each of the substrates is reduced, thereby reducing the number of sub-pixel units loaded by each of the data lines on the corresponding substrate. As a result, each row of the sub-pixel units in the pixel arrangement 3 will have more abundant charging time, so that this pixel arrangement has much stronger charging capability. Similarly, in the embodiment shown in FIGS. 4-6 where the pixel arrangement 3′ is divided into a plurality of columns of sub-pixel unit sets, the odd-numbered columns of sub-pixel unit sets 33 and the even-numbered columns of sub-pixel unit sets 34 are provided on the first substrate 1′ and the second substrate 2′, respectively; and, the first substrate 1′ is provided with gate lines 43 and data lines 53 for driving the odd-numbered columns of sub-pixel unit sets 33, while the second substrate 2′ is provided with gate lines 44 and data lines 54 for driving the even-numbered columns of sub-pixel unit sets 34. Here, the number of the data lines 53 provided on the first substrate 1′ equals the number of columns of the sub-pixel units in the odd-numbered columns of sub-pixel unit sets 33, while the number of the sub-pixel units connected to each of the gate lines 43 provided on the first substrate 1′ equals the number of columns of the sub-pixel units in the odd-numbered columns of sub-pixel unit sets 33. The number of the data lines 54 provided on the second substrate 2′ equals the number of columns of the sub-pixel units in the even-numbered columns of sub-pixel unit sets 34, while the number of the sub-pixel units connected to each of the gate lines 44 provided on the second substrate 2′ equals the number of columns of the sub-pixel units in the even-numbered columns of sub-pixel unit sets 34. In other words, the plurality of columns of sub-pixel unit sets in the abovementioned pixel arrangement 3′ are divided and provided onto two substrates, so that the number of the data lines on each of the substrates is reduced, thereby reducing the number of sub-pixel units loaded by each of the gate lines on the corresponding substrate. As a result, the gates in the pixel arrangement 3′ will have less signal delay, so that this pixel arrangement has much stronger charging capability. Accordingly, in the abovementioned display device, the pixel arrangement has much stronger charging capability. Therefore, the abovementioned display device according to embodiments of the present invention will be more beneficial to realize the design of large size and high resolution display device.

In the display device according to the embodiment shown in FIG. 1 and FIG. 2, the pixel arrangement 3 comprises a plurality of rows of sub-pixel unit sets, and, each row of sub-pixel unit sets comprises one row of sub-pixel units.

In the display device according to the present embodiment, the plurality of rows of sub-pixel unit sets are numbered in sequence. The odd-numbered rows of sub-pixel unit sets 31 and the even-numbered rows of sub-pixel unit sets 32 are provided on the first substrate 1 and the second substrate 2, respectively. Therefore, in case that each row of sub-pixel unit sets comprises one row of sub-pixel units, the sub-pixel units in odd-numbered rows and the sub-pixel units in even-numbered rows are provided on the first substrate 1 and the second substrate 2, respectively. Then, the gate lines 41 for driving the odd-numbered rows of sub-pixel units and the gate lines 42 for driving the even-numbered rows of sub-pixel units are provided on the first substrate 1 and the second substrate 2, respectively, as shown in FIG. 1 and FIG. 2. Here, a spacing between two adjacent gate lines on each of the substrates equals a total length a of two sub-pixel units, which is much more beneficial to manufacture a large size and high resolution display device.

In the display device according to the embodiment shown in FIG. 4 and FIG. 5, the pixel arrangement 3′ comprises a plurality of columns of sub-pixel unit sets, and, each column of sub-pixel unit sets comprises one column of sub-pixel units.

In the display device according to the present embodiment, the plurality columns of sub-pixel unit sets are numbered in sequence. The odd-numbered columns of sub-pixel unit sets 33 and the even-numbered columns of sub-pixel unit sets 34 are provided on the first substrate 1′ and the second substrate 2′, respectively. Therefore, in case that each column of sub-pixel unit sets in the pixel arrangement 3′ comprises one column of sub-pixel units, the sub-pixel units in odd-numbered columns and the sub-pixel units in even-numbered columns are provided on the first substrate 1′ and the second substrate 2′, respectively. Then, the data lines 53 for driving the odd-numbered columns of sub-pixel units and the data lines 54 for driving the even-numbered columns of sub-pixel units are provided on the first substrate 1′ and the second substrate 2′, respectively, as shown in FIG. 4 and FIG. 5. Here, a spacing between two adjacent data lines on each of the substrates equals a total width b of two sub-pixel units, which is much more beneficial to manufacture a large size and high resolution display device.

In the display device according to the embodiment shown in FIGS. 1-3, the pixel arrangement 3 comprises a plurality of rows of sub-pixel unit sets, the first substrate 1 is provided with a first driving circuit that is configured to control drivings of the odd-numbered rows of sub-pixel unit sets 31 and that is in a signal connection with the gate lines 41 and the data lines 51 provided on the first substrate 1, to drive the sub-pixel units in the odd-numbered rows of sub-pixel unit sets 31; while, the second substrate 2 is provided with a second driving circuit that is configured to control drivings of the even-numbered rows of sub-pixel unit sets 32 and that is in a signal connection with the gate lines 42 and the data lines 52 provided on the second substrate 2, to drive the sub-pixel units in the even-numbered rows of sub-pixel unit sets 32.

Referring to FIGS. 1-3, in some embodiments, the first driving circuit may comprise a first gate driving circuit 61 that is in a signal connection with the gate lines 41 provided on the first substrate 1 and a first drain driving circuit 71 that is in a signal connection with the data lines 51 provided on the first substrate 1, the second driving circuit may comprise a second gate driving circuit 62 that is in a signal connection with the gate lines 42 provided on the second substrate 2 and a second drain driving circuit 72 that is in a signal connection with the data lines 52 provided on the second substrate 2. Preferably, both the first gate driving circuit 61 provided on the first substrate 1 and the second gate driving circuit 62 provided on the second substrate 2 are Gate On Array (GOA) circuits, which avoids interference problems caused by gate coating film (Gate COF). Preferably, the first drain driving circuit 71 provided on the first substrate 1 and the second drain driving circuit 72 provided on the second substrate 2 are provided symmetrically on both opposite side edges of the display device.

In the display device according to the embodiment shown in FIGS. 4-6, the pixel arrangement 3′ comprises a plurality of columns of sub-pixel unit sets, the first substrate 1′ is provided with a first driving circuit that is configured to control drivings of the odd-numbered columns of sub-pixel unit sets 33 and that is in a signal connection with the gate lines 43 and the data lines 53 provided on the first substrate 1′, to drive the sub-pixel units in the odd-numbered columns of sub-pixel unit sets 33; while, the second substrate 2′ is provided with a second driving circuit that is configured to control drivings of the even-numbered columns of sub-pixel unit sets 34 and that is in a signal connection with the gate lines 44 and the data lines 54 provided on the second substrate 2′, to drive the sub-pixel units in the even-numbered columns of sub-pixel unit sets 34.

Referring to FIGS. 4-6, in some embodiments, the first driving circuit may comprise a first gate driving circuit 63 that is in a signal connection with the gate lines 43 provided on the first substrate 1′ and a first drain driving circuit 73 that is in a signal connection with the data lines 53 provided on the first substrate 1′, the second driving circuit may comprise a second gate driving circuit 64 that is in a signal connection with the gate lines 44 provided on the second substrate 2′ and a second drain driving circuit 74 that is in a signal connection with the data lines 54 provided on the second substrate 2′. Preferably, both the first gate driving circuit 63 provided on the first substrate 1′ and the second gate driving circuit 64 provided on the second substrate 2′ are Gate On Array (GOA) circuits, which avoids interference problems caused by gate coating film (Gate COF). Preferably, the first drain driving circuit 73 provided on the first substrate 1′ and the second drain driving circuit 74 provided on the second substrate 2′ are provided symmetrically on both opposite side edges of the display device.

In some embodiments, the display device may further comprise a color filter layer (not shown) disposed between the first substrate 1 and the second substrate 2.

In some embodiments, the color filter layer may be manufactured by using COA technology. Specifically, the color filter layer may be arranged in the following three manners.

In a first manner, the color filter layer is arranged on the first substrate 1.

In a second manner, the color filter layer is arranged on the second substrate 2.

In a third manner, referring to the embodiment shown in FIG. 1 and FIG. 2, the pixel arrangement 3 comprises a plurality of rows of sub-pixel unit sets, the color filter layer comprises a first portion corresponding to the odd-numbered rows of sub-pixel unit sets 31 and a second portion corresponding to the even-numbered rows of sub-pixel unit sets 32; and, the first portion of the color filter layer is arranged on the first substrate 1 while the second portion of the color filter layer is arranged on the second substrate 2. Or, referring to the embodiment shown in FIG. 4 and FIG. 5, the pixel arrangement 3′ comprises a plurality of columns of sub-pixel unit sets, the color filter layer comprise a first portion corresponding to the odd-numbered columns of sub-pixel unit sets 33 and a second portion corresponding to the even-numbered columns of sub-pixel unit sets 34; wherein, the first portion of the color filter layer is provided on the first substrate 1′, and the second portion of the color filter layer is provided on the second substrate 2′.

The display device according to embodiments of the present invention may comprise an Organic Light Emitting Diode (OLED) Display or may comprise a Liquid Crystal Display (LCD). The display device according to embodiments of the present invention is beneficial to realize the design of large size and high resolution display device.

Obviously, it would be appreciated by those skilled in the art that various changes or modifications may be made on these embodiments of the present invention without departing from the principles and spirit of the present invention. Accordingly, the present invention intends to contain these changes or modifications if they fall into the scope which is defined in the claims and their equivalents of the present invention.

What is claimed is:

1. A display device, comprising a first substrate and a second substrate which are opposite to each other, and a pixel arrangement disposed between the first substrate and the second substrate; wherein:
the pixel arrangement comprises a plurality of rows of sub-pixel unit sets, and, each row of sub-pixel unit sets comprises at least one row of sub-pixel units; in the pixel arrangement, odd-numbered rows of sub-pixel unit sets and even-numbered rows of sub-pixel unit sets are provided on the first substrate and the second substrate, respectively; and, the first substrate is provided with gate lines and data lines for driving the odd-numbered rows of sub-pixel unit sets, while the second substrate is provided with gate lines and data lines for driving the even-numbered rows of sub-pixel unit sets; or,
the pixel arrangement comprises a plurality of columns of sub-pixel unit sets, and, each column of sub-pixel unit sets comprises at least one column of sub-pixel units; in the pixel arrangement, odd-numbered columns of sub-pixel unit sets and even-numbered columns of sub-pixel unit sets are provided on the first substrate and the second substrate, respectively; and, the first substrate is provided with gate lines and data lines for driving the odd-numbered columns of sub-pixel unit sets, while the second substrate is provided with gate lines and data lines for driving the even-numbered columns of sub-pixel unit sets.

2. The display device of claim 1, wherein each row of sub-pixel unit sets comprises one row of sub-pixel units; or, each column of sub-pixel unit sets comprises one column of sub-pixel units.

3. The display device of claim 1, further comprising a color filter layer disposed between the first substrate and the second substrate.

4. The display device of claim 2, further comprising a color filter layer disposed between the first substrate and the second substrate.

5. The display device of claim 3, wherein the color filter layer is provided on the first substrate; or, the color filter layer is provided on the second substrate.

6. The display device of claim 3, wherein the color filter layer comprises a first portion corresponding to the odd-numbered rows of sub-pixel unit sets and a second portion corresponding to the even-numbered rows of sub-pixel unit sets; or, the color filter layer comprises a first portion corresponding to the odd-numbered columns of sub-pixel unit sets and a second portion corresponding to the even-numbered columns of sub-pixel unit sets;
wherein the first portion of the color filter layer is provided on the first substrate, and the second portion of the color filter layer is provided on the second substrate.

7. The display device of claim 4, wherein the color filter layer is provided on the first substrate; or, the color filter layer is provided on the second substrate.

8. The display device of claim 4, wherein the color filter layer comprises a first portion corresponding to the odd-numbered rows of sub-pixel unit sets and a second portion corresponding to the even-numbered rows of sub-pixel unit sets; or, the color filter layer comprises a first portion corresponding to the odd-numbered columns of sub-pixel unit sets and a second portion corresponding to the even-numbered columns of sub-pixel unit sets;
wherein the first portion of the color filter layer is provided on the first substrate, and the second portion of the color filter layer is provided on the second substrate.

9. The display device of claim 1, further comprising:
a first driving circuit provided on the first substrate and configured to control drivings of the odd-numbered rows of sub-pixel unit sets, and a second driving circuit provided on the second substrate and configured to control drivings of the even-numbered rows of sub-pixel unit sets; or,
a first driving circuit provided on the first substrate and configured to control drivings of the odd-numbered columns of sub-pixel unit sets, and a second driving circuit provided on the second substrate and configured to control drivings of the even-numbered columns of sub-pixel unit sets.

10. The display device of claim 2, further comprising:
a first driving circuit provided on the first substrate and configured to control drivings of the odd-numbered rows of sub-pixel unit sets, and a second driving circuit provided on the second substrate and configured to control drivings of the even-numbered rows of sub-pixel unit sets; or,
a first driving circuit provided on the first substrate and configured to control drivings of the odd-numbered columns of sub-pixel unit sets, and a second driving circuit provided on the second substrate and configured to control drivings of the even-numbered columns of sub-pixel unit sets.

11. The display device of claim 9, wherein the first driving circuit comprises a first gate driving circuit that is in a signal connection with the gate lines provided on the first substrate, the second driving circuit comprises a second gate driving circuit that is in a signal connection with the gate lines provided on the second substrate, and, both the first gate driving circuit and the second gate driving circuit are Gate On Array circuits.

12. The display device of claim 9, wherein the first driving circuit comprises a first drain driving circuit that is in a signal connection with the data lines provided on the first substrate, the second driving circuit comprises a second drain driving circuit that is in a signal connection with the data lines provided on the second substrate, and, the first drain driving circuit and the second drain driving circuit are provided respectively on both opposite side edges of the display device.

13. The display device of claim 10, wherein the first driving circuit comprises a first gate driving circuit that is in a signal connection with the gate lines provided on the first substrate, the second driving circuit comprises a second gate driving circuit that is in a signal connection with the gate lines provided on the second substrate, and, both the first gate driving circuit and the second gate driving circuit are Gate On Array circuits.

14. The display device of claim 10, wherein the first driving circuit comprises a first drain driving circuit that is in a signal connection with the data lines provided on the first substrate, the second driving circuit comprises a second drain driving circuit that is in a signal connection with the data lines provided on the second substrate, and, the first drain driving circuit and the second drain driving circuit are provided respectively on both opposite side edges of the display device.
